(19) United States
(12) Patent Application Publication
(10) Pub. No.: US 2024/0371340 A1
(43) Pub. Date: Nov. 7, 2024

(54) DISPLAY DEVICE AND OPERATING METHOD THEREOF

(71) Applicant: SAMSUNG ELECTRONICS CO., LTD., Suwon-si (KR)

(72) Inventors: Bora LIM, Suwon-si (KR); Hyejoung Park, Suwon-si (KR)

(73) Assignee: SAMSUNG ELECTRONICS CO., LTD., Suwon-si (KR)

(21) Appl. No.: 18/778,694

(22) Filed: Jul. 19, 2024

Related U.S. Application Data
(63) Continuation of application No. PCT/KR2022/020024, filed on Dec. 9, 2022.

(30) Foreign Application Priority Data
Jan. 20, 2022 (KR) 10-2022-0008525
Mar. 10, 2022 (KR) 10-2022-0030322

(51) Int. Cl. G09G 5/00; G06T 5/20; G06T 5/70; G06T 5/92; G06T 7/00; G09G 5/10

(52) U.S. Cl. CPC G09G 5/003; G06T 5/20; G06T 5/70; G06T 5/92; G06T 7/0002; G09G 5/10; G06T 2207/30168; G09G 2320/0233; G09G 2354/00

(57) ABSTRACT

A display device includes: a display; one or more processors; and memory storing one or more instructions that, when executed by the one or more processors, cause the display device to: obtain first brightness information of the display; set one or more image quality processing parameters based on the first brightness information; perform image quality processing on a first image to obtain a second image based on the one or more image quality processing parameters; and control the display to display the second image.

### CROSS-REFERENCE TO RELATED APPLICATIONS

This application is a by-pass continuation application of International Application No. PCT/KR2022/020024, filed on Dec. 9, 2022, which is based on and claims priority to Korean Patent Application No. 10-2022-0008525, filed on Jan. 20, 2022 in the Korean Intellectual Property Office, and Korean Patent Application No. 10-2022-0030322, filed on Mar. 10, 2022 in the Korean Intellectual Property Office, the disclosures of which are incorporated by reference herein in their entireties.

### BACKGROUND

### 1. Field

The disclosure relates to a display device and an operating method thereof, and more particularly, to a display device for performing image quality processing of images and an operating method thereof.

### 2. Description of Related Art

Display devices are devices having the function of displaying images that users can view. Users can watch broadcasts through the display devices. The display devices display, on the displays, broadcasts selected by users from among broadcast signals transmitted from broadcasting stations. Also, smart televisions (TVs) that provide various content in addition to broadcasting functions are being provided. The smart TVs do not passively operate according to the users' selections, but perform the function of analyzing and providing what the users want without any user intervention.

As the performance of display devices becomes more advanced, many methods for improving the image quality of the display devices are being studied. The display devices can perform image quality processing, such as processing to remove noise of images, processing to enhance the details of images, and processing to enhance the contrast ratios of images.

In the case in which image quality processing is performed based on a brightness of a display, adjusting the brightness of the display may cause a change in image quality. The same image signals may be visually deformed and shown according to the brightness of the display. For example, as the brightness of a display becomes higher, the low or mid gray-scale signal becomes brighter and thus, noise, for example, may appear more prominent, and as the brightness of the display becomes lower, noise, for example, may appear reduced. Therefore, there is a problem in that image quality appears differently depending on the brightness of the display.

### SUMMARY

Provided is a display device capable of performing image quality processing of images according to the brightness of a display, and an operating method thereof.

According to an aspect of the disclosure, a display device includes: a display; one or more processors; and memory storing one or more instructions that, when executed by the one or more processors, cause the display device to: obtain first brightness information of the display; set one or more image quality processing parameters based on the first brightness information; perform image quality processing on a first image to obtain a second image based on the one or more image quality processing parameters; and control the display to display the second image.

The image quality processing may include at least one of noise processing, detail enhancement processing, or contrast ratio enhancement processing.

The display device may be further configured to execute the one or more instructions to: adjust a gain of a noise filter used for the noise processing based on the first brightness information; and obtain the second image by filtering the first image based on the noise filter.

The noise filter may include a low-pass filter, and the display device may be further configured to execute the one or more instructions to: increase the gain of the noise filter based on a brightness value indicated by the first brightness information increasing; and decrease the gain of the noise filter based on the brightness value decreasing.

The display device may be further configured to execute the one or more instructions to: adjust a gain of a detail enhancement filter used for the detail enhancement processing based on the first brightness information and the gain of the noise filter, and obtain the second image by filtering the first image based on the detail enhancement filter.

The detail enhancement filter may include a high-pass filter, and the display device may be further configured to execute the one or more instructions to: increase the gain of the detail enhancement filter based on the gain of the noise filter increasing; and decrease the gain of the detail enhancement filter based on the gain of the noise filter decreasing.

The display device may be further configured to execute the one or more instructions to: set a contrast ratio enhancing curve used for the contrast ratio enhancement processing based on the first brightness information; and obtain the second image based on applying the contrast ratio enhancing curve to the first image.

The display device may be further configured to execute the one or more instructions to set the contrast ratio enhancing curve based on mapping information in which a plurality of contrast ratio enhancing curves are mapped to second brightness information of the display.

The display device may further include a wireless communicator configured to receive a user input for adjusting brightness of the display, and the display device may be further configured to execute the one or more instructions to obtain the first brightness information based on the user input for adjusting the brightness of the display.

The user input may include at least one of an input for changing a screen mode of the display, an input for adjusting a backlight, or an input for adjusting screen brightness.

According to an aspect of the disclosure, an operating method of a display device, includes: obtaining first brightness information of a display; setting one or more image quality processing parameters based on the first brightness information; performing image quality processing on a first image to obtain a second image based on the one or more image quality processing parameters; and displaying the second image.

The image quality processing may include at least one of noise processing, detail enhancement processing, or contrast ratio enhancement processing.

The setting the one or more image quality processing parameters may include adjusting a gain of a noise filter used for the noise processing based on the first brightness information, and the performing the image quality processing on the first image may include filtering the first image based on the noise filter, to obtain the second image.

The noise filter may include a low-pass filter, and the adjusting the gain of the noise filter may include: increasing the gain of the noise filter based on a brightness value indicated by the first brightness information increasing; and decreasing the gain of the noise filter based on the brightness value decreasing.

According to an aspect of the disclosure, a non-transitory computer-readable recording medium having instructions recorded thereon, that, when executed by one or more processors, cause the one or more processors to: obtain first brightness information of the display; set one or more image quality processing parameters based on the first brightness information; perform image quality processing on a first image to obtain a second image based on the one or more image quality processing parameters; and control the display to display the second image.

### DESCRIPTION OF THE DRAWINGS

The above and other aspects, features, and advantages of certain embodiments of the present disclosure are more apparent from the following description taken in conjunction with the accompanying drawings, in which:

FIG. 1 shows a display device according to one or more embodiments.

FIG. 2 is a flowchart illustrating an operating method of a display device according to one or more embodiments.

FIGS. 3A and 3B show examples in which brightness information of a display changes based on a user input, according to one or more embodiments.

FIG. 4 shows a device (or a module) for performing image quality processing of images, according to one or more embodiments.

FIG. 5 shows a noise processor according to one or more embodiments.

FIG. 6 shows graphs representing relationships between brightness information of a display and gains of a noise filter, according to one or more embodiments.

FIG. 7 shows a detail enhancing unit, according to one or more embodiments.

FIG. 8 shows a contrast ratio enhancing unit according to one or more embodiments.

FIG. 9 shows mapping information representing relationships between contrast ratio enhancing curves and brightness information of a display, according to one or more embodiments.

FIG. 10 is a block diagram showing a configuration of a display device according to one or more embodiments.

FIG. 11 is a block diagram showing a configuration of a display device according to one or more embodiments.

### DETAILED DESCRIPTION

The embodiments described in the disclosure, and the configurations shown in the drawings, are only examples, and various modifications may be made without departing from the scope and spirit of the disclosure.

Terms used in the disclosure will be briefly described, and the disclosure will be described in detail.

Although general terms being currently widely used were selected as terminology used in the present disclosure while considering the functions of the present disclosure, they may vary according to intentions of one of ordinary skill in the art, judicial precedents, the advent of new technologies, and the like. Terms arbitrarily selected by the applicant may also be used in a specific case. In this case, their meanings will be described in detail in the detailed description of the disclosure. Hence, the terms used in the present disclosure must be defined based on the meanings of the terms and the entire contents of the present disclosure, not by simply stating the terms themselves.

In the disclosure, it will be understood that when a certain part “includes” a certain component, the part does not exclude another component but can further include another component, unless the context clearly dictates otherwise. As used herein, the terms “portion”, “module”, for example, refer to a unit that performs at least one function or operation, and may be implemented as hardware, software, or a combination of hardware and software.

Hereinafter, embodiments will be described in detail with reference to the accompanying drawings so that the present disclosure may be readily implemented by one of ordinary skill in the technical field to which the present disclosure pertains. However, the present disclosure can be implemented in various different forms, and is not limited to the embodiments described herein. Also, throughout the disclosure, similar components are assigned like reference numerals.

In one or more embodiments, the term “user” means a person who controls a system, functions, or operations, and may include a developer, a manager, or an installation engineer.

Also, in one or more embodiments, an ‘image’ or a ‘picture’ may denote a still image, a moving image configured with a plurality of consecutive still images (or frames), or a video.

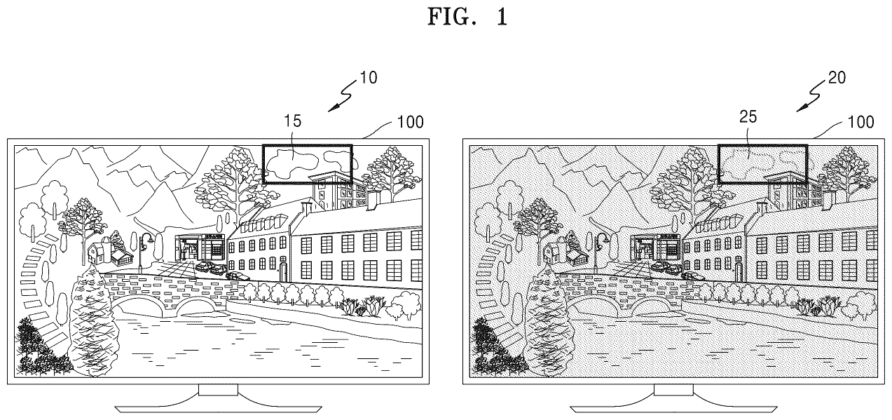

FIG. 1 shows a display device according to one or more embodiments.

Referring to FIG. 1, a display device 100 according to one or more embodiments may be an electronic device that receives an image from an external device or an external server and performs image quality processing on the received image. For example, the display device 100 may be implemented in various types, such as a television (TV), a mobile phone, a tablet personal computer (PC), a digital camera, a camcoder, a laptop computer, a desktop, an e-book terminal, a digital broadcasting terminal, Personal Digital Assistant (PDA), Portable Multimedia Player (PMP), a navigation, a MP3 player, or a wearable device. Also, the display device 100 may be a fixed electronic device positioned at a fixed location or a mobile electronic device in a portable type, or may be a digital broadcasting receiver capable of receiving digital broadcasting. Embodiments may be implemented in image processing devices such as TVs having a large display, although not limited thereto.

The display device 100 according to one or more embodiments may include a display and display an image subject to image quality processing on the display. At this time, images subject to the same image quality processing may be displayed with different image quality on the display at different brightness of the display. For example, at high brightness of the display, an image 15 displayed on the display may appear prominent in noise, artifacts, or contours. In contrast, at low brightness of the display, an image 25 displayed on the display may appear reduced in noise, artifacts, or contours, for example. Accordingly, to display images with constant image quality even at different brightness of the display, adaptive image quality processing may be performed depending on the brightness of the display.

The display device 100 according to one or more embodiments may perform different image processing on images according to brightness of the display such that images subject to image quality processing are displayed with constant image quality on the display even at different brightness of the display.

A method in which the display device 100 according to one or more embodiments performs image quality processing on images according to brightness of the display will be described in detail with reference to the drawings, below.

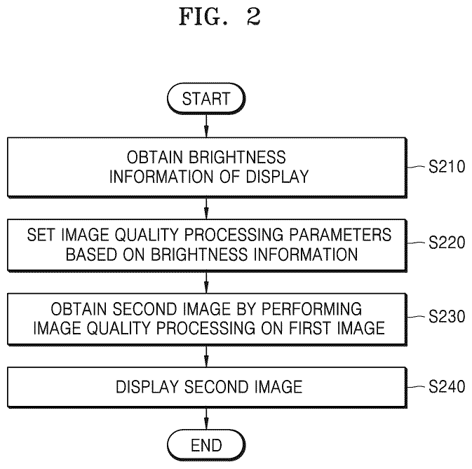

FIG. 2 is a flowchart illustrating an operating method of a display device according to one or more embodiments.

Referring to FIG. 2, the display device 100 according to one or more embodiments may obtain brightness information of a display (S210).

The display of the display device 100 according to one or more embodiments may include a display panel and a backlight unit, and the brightness information of the display may include brightness information of the backlight unit, although not limited thereto.

The display device 100 may obtain brightness information of the display at preset time intervals or based on brightness of the display changing. At this time, a brightness value of the display may have a range of a first value to a second value, and a greater brightness value may represent higher brightness of the display, although not limited thereto.

Brightness of the display according to one or more embodiments may be set or changed through a user menu. For example, according to reception of a user input for adjusting brightness of the display, the display device 100 may change brightness of the display. According to a change of ambient illuminance around the display device 100, the display device 100 may change brightness of the display based on the changed illuminance, although not limited thereto. However, the display device 100 may change brightness of the display according to various conditions.

The display device 100 according to one or more embodiments may set image quality processing parameters based on the brightness information of the display (S220). For example, the display device 100 may perform image quality processing, such as noise processing, detail enhancement processing, and contrast ratio enhancement processing, on an input image.

The noise processing may mean processing of removing or reducing noise included in an image. An image according to one or more embodiments may include various noise. For example, noise may mean a phenomenon in which irregular dots appear in an image to distort a shape of an object included in the image. Also, noise may include artifacts that appear due to image compression, and the artifacts may include a ringing phenomenon (Mosquito noise) in which small dots appear to twinkle around the edges of objects included in the image, or a phenomenon (block noise) in which small square blocks appear in areas where there are motions in the image. The artifacts may include a phenomenon in which outlines such as stripes or waves appear in flat areas, not the actual outlines of the objects included in the image.

The display device 100 may remove or reduce noise included in the image by using a noise filter. In this case, the noise filter according to one or more embodiments may include a low-pass filter. The low-pass filter may include a Gaussian filter or an average filter, although not limited thereto.

The display device 100 may detect an area where noise exists from the image and apply the noise filter to the detected area. The display device 100 may apply the noise filter to an entire of the image. Also, the display device 100 may obtain a noise-processed image by a weighted sum of the original image to which the noise filter has not been applied and the image to which the noise filter has been applied, although not limited thereto.

The display device 100 may adjust a gain of the noise filter or a weight used to perform a weighted sum of the original image and the image to which the noise filter has been applied, based on the brightness information of the display.

The detail enhancement processing may mean processing of sharpening edges or image details included in an image.

The display device 100 may sharpen edges or image details included in the image by using a detail enhancement filter (sharpening). In this case, the detail enhancement filter according to one or more embodiments may include a high-pass filter. The high-pass filter may include a Laplacian filter, a Prewitt filter, a sobel filter, or a Roberts Cross filter, for example, although not limited thereto.

The display device 100 may detect edges or image details from the image, and apply the detail enhancement filter to an area including edges or image details or to the entire of the image. Also, the display device 100 may obtain a detail-enhanced image by a weighted sum of the original image to which the detail enhancement filter has not been applied and the image to which the detail enhancement filter has been applied, although not limited thereto.

The display device 100 may adjust a gain of the detail enhancement filter based on brightness information of the display and a gain of the noise filter. Also, the display device 100 may adjust a weight used to perform the weighted sum of the original image and the image to which the detail enhancement filter has been applied, based on the brightness information of the display.

The contrast ratio enhancement processing may be processing for enhancing gray-scale expression of an image, and may be performed by applying a contrast ratio enhancing curve to an image. For example, the display device 100 may obtain an image (output image) with an enhanced contrast ratio by applying a contrast ratio enhancing curve to an image (input image). The contrast ratio enhancing curve may be expressed on a two-dimensional plane including x- and y-axes, wherein the x-axis represents input brightness values of pixels and the y-axis represents output brightness values of the pixels. The display 100 may obtain an output image by changing brightness values of pixels included in the input image according to the contrast ratio enhancing curve.

The display device 100 may set a contrast ratio enhancing curve based on the brightness information of the display. For example, the display device 100 may set a shape or slope of a contrast ratio enhancing curve based on the brightness information of the display.

The display device 100 according to one or more embodiments may obtain a second image by performing image quality processing on a first image (S230).

The display device 100 according to one or more embodiments may receive the first image from an external device or an external server, or receive an input of the first image. The first image may be an image stored in advance in the display device 100. The display device 100 may perform image quality processing by applying the image quality processing parameters set in operation 220 to the first image. For example, the display device 100 may perform image quality processing, such as noise processing, detail enhancement processing, and contrast ratio enhancement processing, on the first image, and image quality processing parameters that are applied to each image quality processing may be the image quality processing parameters set based on the brightness information of the display in operation 220 (S220). The image quality processing parameters may include the gain of the noise filter, the gain of the detail enhancement filter, or the contrast ratio enhancing curve, for example.

The display device 100 may display the second image on which image quality processing has been performed (S240).

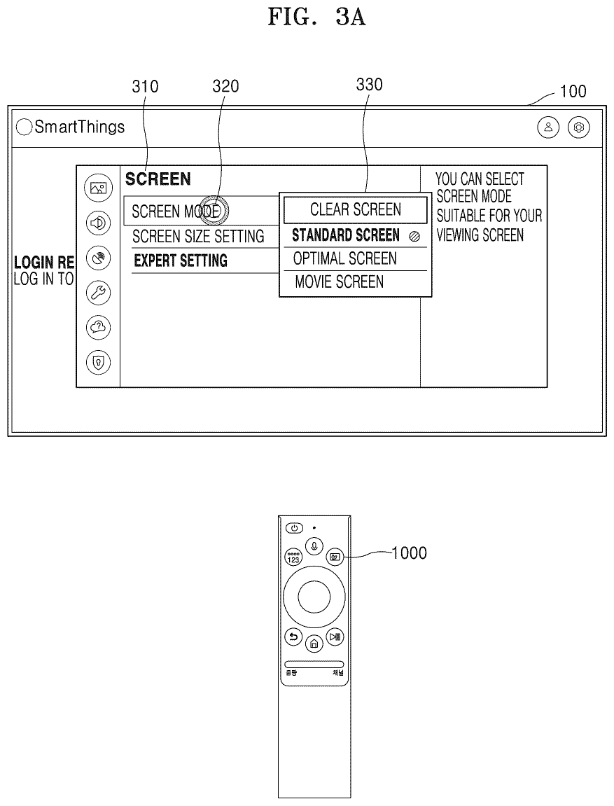

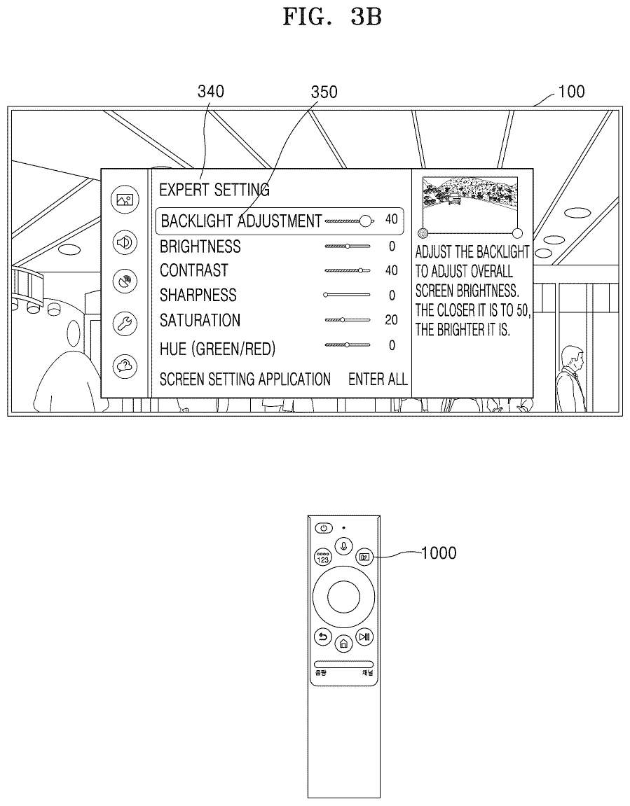

FIGS. 3A and 3B show examples in which brightness information of a display changes based on a user input, according to one or more embodiments.

Referring to FIG. 3A, the display device 100 according to one or more embodiments may provide a function for changing screen settings. For example, the display device 100 may include a screen setting menu 310 in a setting menu.

As shown in FIG. 3A, according to a selection of a screen mode menu 320 based on a user input, the display device 100 may display a menu 330 for selecting a type of a screen mode. The menus 310, 320, and 330 shown in FIG. 3A are only an exemplary configuration, although not limited thereto, and various configurations may be possible.

At this time, a user of the display device 100 may use a control device 1000 to transmit a control signal or a control command corresponding to a user input (for example, an input through a key or button of the control device) to the display device 100. The display device 100 may receive the control signal or the control command from the control device 1000 and perform an operation corresponding to the user input.

The display device 100 may select a type of a screen mode based on the user input. In this case, each screen mode of the display device 100 may include preset brightness information of the display. For example, a brightness value of the display set for clear screen may be greater than a brightness value of the display set for standard screen or a brightness value of the display set for movie screen.

Accordingly, based on a screen mode changing, brightness information of the display may change.

Also, referring to FIG. 3B, according to a selection of an expert setting menu 340 included in the screen setting menu of FIG. 3A based on a user input, the display device 100 according to one or more embodiments may display a backlight adjustment menu 350 and menus for adjusting brightness, contrast, sharpness, or saturation, for example. The menus 340 and 350 shown in FIG. 3B may be only an exemplary configuration, although limited thereto, and various configurations may be possible.

The user of the display device 100 may select the backlight adjustment menu 350 for adjusting brightness of the backlight unit in the expert setting menu 340 by using the control device 1000, and manually adjust a setting value (for example, a brightness value of the backlight unit). For example, the display device 100 may adjust the brightness of the backlight unit by decreasing or increasing the corresponding setting value based on a user input of moving a slide bar left or right. Accordingly, the brightness information of the display may change.

Also, by changing a setting value of the brightness menu, the brightness information of the display may change.

Meanwhile, although an example in which brightness information of the display is changed manually based on a user input is shown in FIGS. 3A and 3B and described, the disclosure is not limited thereto.

The display device 100 according to one or more embodiments may provide a function of automatically adjusting brightness information of the display based on ambient illuminance information, and while the corresponding function is activated, the display device 100 may automatically change brightness information of the display based on ambient illuminance information.

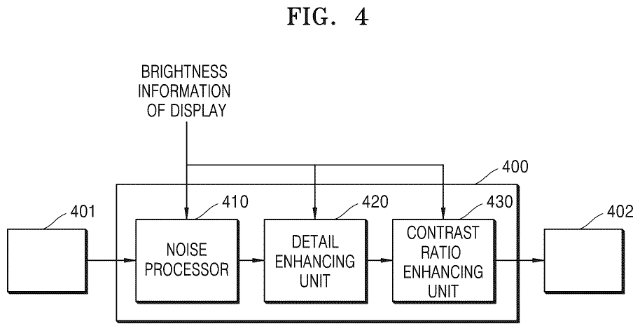

FIG. 4 shows a device (or module) for performing image quality processing of images according to one or more embodiments.

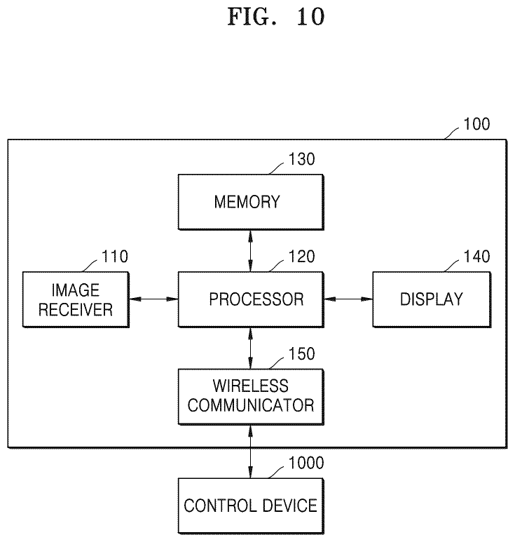

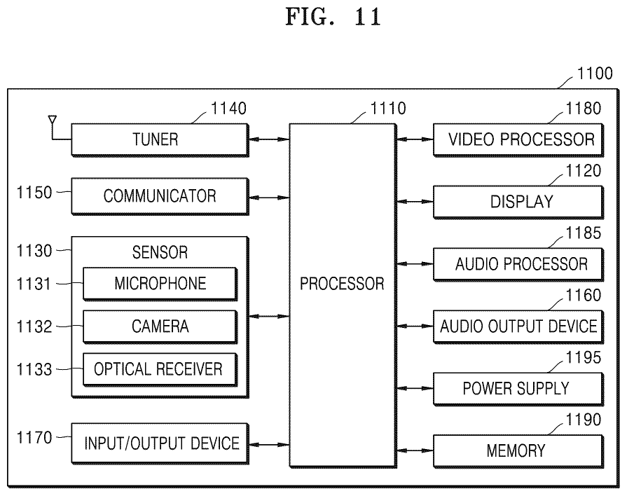

An image quality processor (or module) 400 may be included in a part of the display device 100 shown in FIG. 10 or a part of a display device 1100 shown in FIG. 11.

Referring to FIG. 4, the image quality processor (or module) 400 according to one or more embodiments may include a noise processor 410, a detail enhancing unit 420, and a contrast ratio enhancing unit 430.

The noise processor 410 may include an appropriate logic, circuit, interface, and/or code that operates to remove or reduce noise in an entire or a part of an image.

The noise processor 410 may set one or more first parameters that are applied to noise processing, based on brightness information of the display. Herein, the first parameters may include a kind of a noise filter, a gain of the noise filter, and a weight that is applied to perform a weighted sum of an image to which the noise filter has been applied and an image to which the noise filter has not been applied.

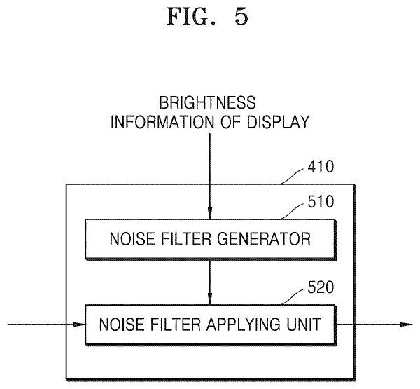

The noise processor 410 may perform noise filtering on an image (for example, a first image 401) input to the noise processor 410 by using the set first parameters. An operation that is performed by the noise processor 410 will be described in detail with reference to FIG. 5.

The detail enhancing unit 420 may include an appropriate logic, circuit, interface, and/or code that operates to enhance details in an entire or a part of an image.

The detail enhancing unit 420 may set one or more second parameters that are applied to detail enhancement processing, based on brightness information of the display. Herein, the second parameters may include a kind of a detail enhancement filter, a gain of the detail enhancement filter, and a weight that is applied to perform a weighted sum of an image to which the detail enhancement filter has been applied and an image to which the detail enhancement filter has not been applied.

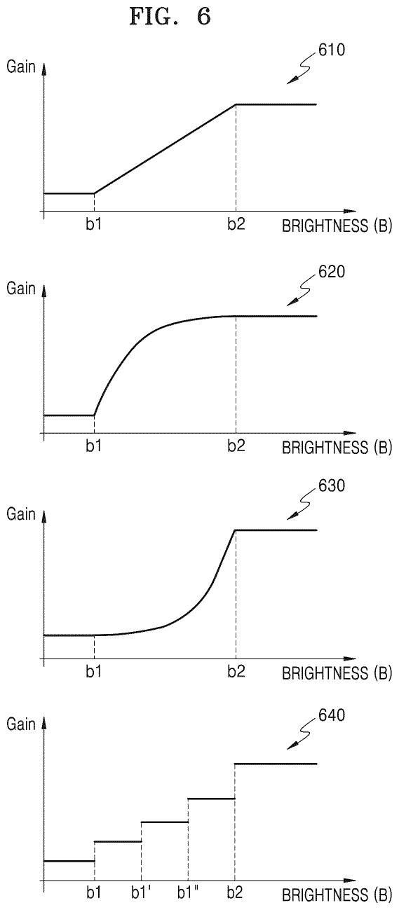

The detail enhancing unit 420 may perform detail enhancement processing on an image (for example, an image output from the noise processor 410) input to the detail enhancing unit 420 by using the set second parameters. An operation that is performed by the detail enhancing unit 420 will be described in detail with reference to FIG. 6.

The contrast ratio enhancing unit 430 may include an appropriate logic, circuit, interface, and/or code that operates to enhance a contrast ratio in an entire or a part of an image.

The contrast ratio enhancing unit 430 may set one or more third parameters that are applied to contrast ratio enhancement processing, based on brightness information of the display. Herein, the third parameters may include an area to which a contrast ratio enhancing curve is applied, or a shape or slope of the contrast ratio enhancing curve, for example.

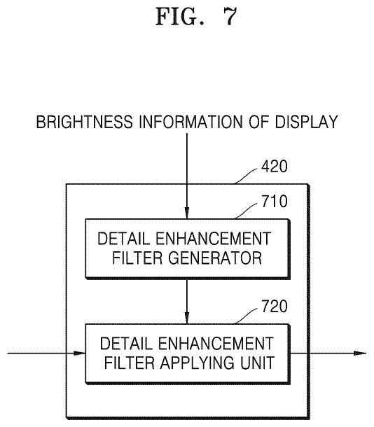

The contrast ratio enhancing unit 430 may perform contrast ratio enhancement processing on an image (for example, an image output from the detail enhancing unit 420) input to the contrast ratio enhancing unit 430 by using the set third parameters. An operation that is performed by the contrast ratio enhancing unit 430 will be described in detail with reference to FIG. 7.

Accordingly, the image quality processor (or module) 400 may output a second image 402 by performing noise processing, detail enhancement processing, and contrast ratio enhancement processing on the first image 401.

However, although a case in which the image quality processor (or module) 400 performs image quality processing in the order of noise processing, detail enhancement processing, and contrast ratio enhancement processing is shown in FIG. 4 and described, the order of noise processing, detail enhancement processing, and contrast ratio enhancement processing may change.

FIG. 5 shows a noise processor according to one or more embodiments.

Referring to FIG. 5, the noise processor 410 according to one or more embodiments may include a noise filter generator 510 and a noise filter applying unit 520.

The noise filter generator 510 may set a noise filter to be applied to an image. For example, the noise filter may include a low-pass filter. The low-pass filter may mean a filter composed of an operational amplifier with a resistor in series and a capacitor in parallel, and may be implemented in a way that passes a frequency band lower than a given cutoff frequency and attenuates a frequency band higher than the cutoff frequency.

The low-pass filter may include a Gaussian filter, or an average filter, for example. The noise filter generator 510 may set a kind of a noise filter and a gain of the noise filter, which are to be applied to an entire of an image or each area included in the image, based on brightness information of the display.

Because noise included in an image appears more prominent at higher brightness of the display, the noise filter generator 510 may increase intensity of noise filtering as the brightness of the display increases. For example, the noise filter generator 510 may increase a gain of the noise filter as brightness (a brightness value) of the display increases, and decrease a gain of the noise filter as the brightness (a brightness value) of the display decreases. A relationship between the brightness of the display and the gain of the noise filter will be described in detail with reference to FIG. 6.

FIG. 6 shows graphs representing relationships between brightness information of a display and gains of a noise filter, according to one or more embodiments.

Referring to FIG. 6, first to fourth graphs 610, 620, 630, and 640 are graphs illustrating relationships between gains of the noise filter and brightness information B of the display according to one or more embodiments.

Referring to the first graph 610 of FIG. 6, in the case in which a brightness value B of the display is between a first threshold value b₁ and a second threshold value b₂, a gain of the noise filter and the brightness value of the display may have a linear relationship, and as the brightness value of the display increases, the gain of the noise may also increase linearly. The first graph 610 may be expressed by Equation 1 below.

$$Gain = \{ \begin{matrix}{c}_{1} , & B < {b}_{1} \\ {c}_{2} - {c}_{1} / ( {b}_{2} - {b}_{1} ) , B - b 1 ) + {c}_{1} , & {b}_{1} \leq B \leq {b}_{2} \\ {c}_{2} ( Max ) & {b}_{2} < B\end{matrix} \qquad [ Equation 1 ]$$

In Equation 1, c₁ and c₂ may be preset constant values.

Also, referring to the second graph 620 and the third graph 630, in the case in which the brightness value B of the display is between the first threshold value b₁ and the second threshold value b₂, a gain of the noise filter and the brightness value of the display may have a non-linear relationship, and as the brightness value of the display increases, the gain of the noise filter may also increase. The second graph 620 and the third graph 630 may be expressed by Equation 2 below.

$$Gain = \{ \begin{matrix}{c}_{1} , & B < {b}_{1} \\ {B}^{x} + {c}_{1} , & {b}_{1} \leq B \leq {b}_{2} \\ {c}_{2} ( Max ) , & {b}_{2} < B\end{matrix} \qquad [ Equation 2 ]$$

In Equation 2, c₁, c₂, and x may be preset constant values.

Meanwhile, the first threshold value b₁ and the second threshold value b₂ of the first to third graphs 610, 620, and 630 may be set based on a brightness range of the display. For example, in the case in which a brightness value of the display is set between a first value (minimum value, for example, 0) and a second value (maximum value, for example, 50), the first threshold value b₁ and the second threshold value b₂ may be set by the first value and the second value. The first threshold value b₁ may be set to a value between 20% and 30% of the second value, and the second threshold value b₂ may be set to a value between 80% and 90% of the second value, although not limited thereto.

Also, the first gain c₁ and the second gain c₂ may be set based on the brightness range of the display. For example, the second gain c₂ may be equal to the second value, and the first gain c₁ may be set to a value resulting from multiplying the second gain c₂ by a value between 0.1 and 0.9, although not limited thereto.

Also, referring to the fourth graph 640, as the brightness value B of the display increases, the gain of the noise filter may increase in the form of a step. Referring again to FIG. 5, the noise filter generator 510 according to one or more embodiments may set a gain of the noise filter based on any graph of the first to fourth graphs 610, 620, 630, and 640 and brightness information of the display.

Also, the noise filter applying unit 520 may detect an area where noise exists in an image, and apply a noise filter set by the noise filter generator 610 to the detected area. The noise filter applying unit 520 may apply the noise filter to an entire of the image.

The noise filter applying unit 520 may obtain a noise-processed image by using a weighted sum of the image to which the noise filter has not been applied and the image to which the noise filter has been applied. The noise filter applying unit 520 may obtain the noise-processed image by applying a first weight to the image to which the noise filter has been applied and applying a second weight (for example, 1-first weight) to the image to which the noise filter has not been applied to perform the weighted sum. At this time, the noise filter applying unit 520 may adjust the first weight based on the brightness information of the display.

FIG. 7 shows a detail enhancing unit according to one or more embodiments.

Referring to FIG. 7, the detail enhancing unit 420 according to one or more embodiments may include a detail enhancement filter generator 710 and a detail enhancement filter applying unit 720.

The detail enhancement filter generator 710 may set a detail enhancement filter to be applied to an image. For example, the detail enhancement filter may mean a filter for enhancing image details by extracting high-frequency components including the image details and emphasizing the extracted high-frequency components. The detail enhancement filter may include a high-pass filter, although not limited thereto.

The high-pass filter may include a Laplacian filter, a Prewitt filter, a sobel filter, or a Roberts Cross filter, for example, although not limited thereto. The detail enhancement filter generator 710 may set a kind of a detail enhancement filter and a gain of the detail enhancement filter, which are to be applied to an entire of an image or each area included in the image, based on brightness information of the display.

The detail enhancement filter generator 710 may set a gain of a detail enhancement filter, based on a gain of a noise filter set by the noise filter generator 510. In the case in which a gain of the noise filter changes according to brightness of the display, a gain of the detail enhancement filter may also be adjusted to balance image quality. Also, because sharpness of an image changes according to brightness of the display, the detail enhancement filter generator 710 may adjust a gain of the detail enhancement filter. For example, according to an increase of a gain of the noise filter, the detail enhancement filter generator 710 may increase a gain of the detail enhancement filter, and according to a decrease of a gain of the noise filter, the detail enhancement filter generator 710 may decrease a gain of the detail enhancement filter. A gain of the detail enhancement filter may be adjusted in a linear relationship with a gain of the noise filter.

The detail enhancement filter applying unit 720 may extract a high-frequency area in which high-frequency components including image details are included, and apply a detail enhancement filter set in the detail enhancement filter generator 710 to the high-frequency area. The detail enhancement filter applying unit 720 may apply the detail enhancement filter to an entire of an image.

The detail enhancement filter applying unit 720 may obtain a detail-enhanced image by using a weighted sum of an image to which the detail enhancement filter has not been applied and an image to which the detail enhancement filter has been applied.

The detail enhancement filter applying unit 720 may obtain a detail-enhanced image by applying a third weight to the image to which the detail enhancement filter has been applied and applying a fourth weight (for example, 1-third weight) to the image to which the detail enhancement filter has not been applied to perform a weighted sum. At this time, the detail enhancement filter applying unit 720 may adjust the third weight based on brightness information of the display, and edges or image details included in the image may be more sharpened upon application of a greater third weight.

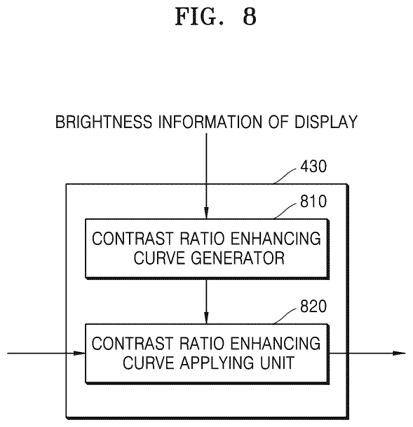

FIG. 8 shows a contrast ratio enhancing unit according to one or more embodiments.

Referring to FIG. 8, the contrast ratio enhancing unit 430 may include a contrast ratio enhancing curve generator 810 and a contrast ratio enhancing curve applying unit 820.

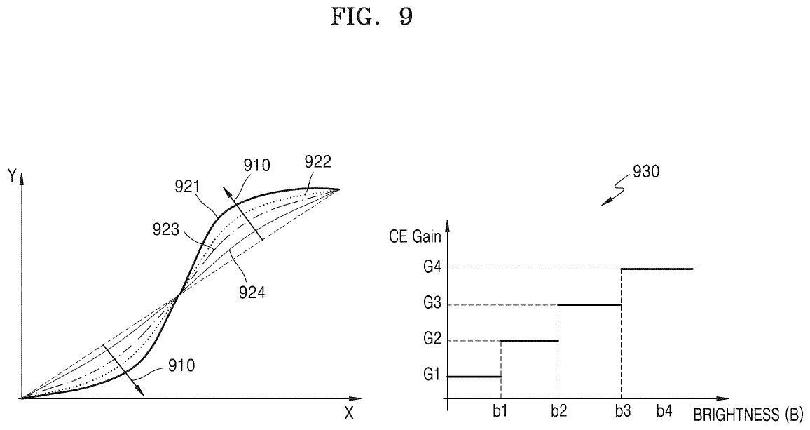

The contrast ratio enhancing curve generator 810 may set a contrast ratio enhancing curve to be applied to an image. For example, the contrast ratio enhancing curve may be expressed on a two-dimensional plane including x- and y-axes, wherein the x-axis represents input brightness values of pixels and the y-axis represents output brightness values of the pixels. The contrast ratio enhancing curve generator 810 may set a shape or slope of a contrast ratio enhancing curve to be applied to an image, based on brightness information of the display. This will be described in detail with reference to FIG. 9.

FIG. 9 shows mapping information representing relationships between contrast ratio enhancing curves and brightness information of a display according to one or more embodiments.

The contrast ratio enhancing curve generator 810 may have stored a plurality of contrast ratio enhancing curves having various shapes and slopes in advance. The more the contrast ratio enhancing curves bend in a first direction 910, the more gains of contrast ratio enhancement may increase. An output image to which a contrast ratio enhancing curve bent steeply in the first direction 910 has been applied may show pixels having low brightness values with lower brightness and pixels having high brightness values with higher brightness. Accordingly, a contrast ratio of the output image may be more enhanced.

For example, the contrast ratio enhancing curve generator 810 may generate first to fourth contrast ratio enhancing curves 921, 922, 923, and 924, and at this time, a contrast ratio in a case in which contrast ratio enhancement processing is performed by applying the first contrast ratio enhancing curve 921 to an image may be more enhanced than that in a case in which contrast ratio enhancement processing is performed by applying the fourth contrast ratio enhancing curve 924 to the image.

The contrast ratio enhancing curve generator 810 according to one or more embodiments may identify a contrast ratio enhancing curve to be applied to an image from among the plurality of contrast ratio enhancing curves, based on mapping information in which the plurality of contrast ratio enhancing curves are mapped to brightness information of the display. For example, the mapping information may be in the form of a look-up table (LUT), although not limited thereto.

As shown in FIG. 9, the mapping information 930 may be in a form in which a contrast ratio enhancement gain (CE Gain) increases stepwise toward higher brightness information of the display. For example, according to a brightness value of the display being between 0 and a first brightness value b₁, the contrast ratio enhancement gain may have a first gain G1, and the first gain G1 may be mapped to the fourth contrast ratio enhancing curve 924. Also, according to a brightness value of the display being between the first brightness value b₁ and a second brightness value b₂, the contrast ratio enhancement gain may have a second gain G2, and the second gain G2 may be mapped to the third contrast ratio enhancing curve 923.

Also, according to a brightness value of the display being between the second brightness value b₂ and a third brightness value b₃, the contrast ratio enhancement gain may have a third gain G3, and the third gain G3 may be mapped to the second contrast ratio enhancing curve 922.

Also, according to a brightness value of the display being between the third brightness value b₃ and a fourth brightness value b₄, the contrast ratio enhancement gain may have a fourth gain G4, and the fourth gain G4 may be mapped to the first contrast ratio enhancing curve 921.

Referring again to FIG. 8, the contrast ratio enhancing curve applying unit 820 may perform contrast ratio enhancement processing by applying a contrast ratio enhancing curve set in the contrast ratio enhancing curve generator 810 to an entire of an image or each area of the image.

FIG. 10 is a block diagram showing a configuration of a display device according to one or more embodiments.

Referring to FIG. 10, the display device 100 according to one or more embodiments may include an image receiver 110, a processor 120, a memory 130, a display 140, and a wireless communicator 150.

The image receiver 110 according to one or more embodiments may include a communication interface and an input/output interface. For example, the communication interface may transmit/receive data or a signal to/from an external device or a server. For example, the communication interface may include a wireless-fidelity (Wi-Fi) module, a Bluetooth module, an infrared communication module, a wireless communication module, a local area network (LAN) module, an Ethernet module, and a wired communication module. In this case, each communication module may be implemented as at least one hardware chip.

The Wi-Fi module and the Bluetooth module may perform communication by a Wi-Fi method and a Bluetooth method, respectively. In the case in which the Wi-Fi module or the Bluetooth module is used, various connection information, such as a service set identifier (SSID) or a session key, may be first transmitted/received, communication may be established through the connection information, and various information may be transmitted or received. The wireless communication module may include at least one communication chip that performs communication according to various wireless communication standards, such as zigbee, 3^{rd} Generation (3G), 3^{rd} Generation Partnership Project (3GPP), Long Term Evolution (LTE), LTE Advanced (LTE-A), 4^{th} Generation (4G), and 5^{th} Generation (5G).

Also, the input/output interface may receive video (for example, moving image), audio (for example, voice or music), and additional information (for example, Electronic Program Guide (EPG)) from outside of the display device 100. The input/output interface may include any one among a High-Definition Multimedia Interface (HDMI), Mobile High-Definition Link (MHL), Universal Serial Bus (USB), Display Port (DP), Thunderbolt, a Video Graphics Array (VGA) port, a RGB port, D-subminiature (D-SUB), Digital Visual Interface (DVI), a component jack, or a PC port.

The image receiver 110 according to one or more embodiments may receive one or more images.

The processor 120 according to one or more embodiments may perform a function of controlling overall operations of the display device 100 and signal flows between internal components of the display device 100 and processing data.

The processor 120 may include a single core, a dual core, a triple core, a quad core, and a multiple core. Also, the processor 120 may include a plurality of processors. For example, the processor 120 may be implemented with a main processor and a sub processor that operates in a sleep mode.

Also, the processor 120 may include at least one of a Central Processing Unit (CPU), a Graphic Processing Unit (GPU), or a Video Processing Unit (VPU). According to some embodiments, the processor 120 may be implemented in the form of a System On Chip (SOC) into which at least one of CPU, GPU, or VPU is integrated.

The memory 130 according to one or more embodiments may store various data, programs, or applications for driving and controlling the display device 100.

Also, the programs stored in the memory 130 may include one or more instructions. The programs (one or more instructions) or applications stored in the memory 130 may be executed by the processor 120.

The processor 120 according to one or more embodiments may include at least one among components included in the image quality processor (or module) 400 of FIG. 4.

The processor 120 according to one or more embodiments may obtain brightness information of the display 140. The processor 120 may obtain brightness information of the display at preset time intervals or based on brightness of the display changing. Herein, a brightness value of the display may range from the first value to the second value, and a greater brightness value may represent higher brightness of the display, although not limited thereto.

Brightness of the display according to one or more embodiments may be set or changed through a user menu. For example, according to reception of a user input for adjusting brightness of the display, the processor 120 may change the brightness of the display. According to a change of ambient illuminance around the display device 100, the processor 120 may change the brightness of the display according to the changed illuminance, although not limited thereto. However, the brightness of the display may change according to various conditions.

The processor 120 according to one or more embodiments may set image quality parameters based on brightness information of the display. For example, the processor 120 may perform image quality processing, such as noise processing, detail enhancement processing, and contrast ratio enhancement processing, on an input image.

The noise processing may mean processing of removing or reducing noise included in an image. The processor 120 may remove or reduce noise included in an image by using a noise filter. In this case, the noise filter according to one or more embodiments may include a low-pass filter. The low-pass filter may include a Gaussian filter, or an average filter, for example, although not limited thereto.

The processor 120 may adjust a gain of the noise filter based on brightness information of the display. The processor 120 may detect an area in which noise exists in an image, and apply the noise filter to the detected area. The processor 120 may apply the noise filter to an entire of the image.

Also, the processor 120 may obtain a noise-processed image by a weighted sum of an original image to which the noise filter has not been applied and an image to which the noise filter has been applied, although not limited thereto. At this time, the processor 120 may adjust a weight of the image to which the noise filter has been applied, based on brightness information of the display, although not limited thereto.

The detail enhancement processing may mean processing of sharpening edges or image details included in an image.

The processor 120 may sharpen edges or image details included in an image by using a detail enhancement filter (sharpening). At this time, the detail enhancement filter according to one or more embodiments may include a high-pass filter. The high-pass filter may include a Laplacian filter, a Prewitt filter, a sobel filter, or a Roberts Cross filter, for example, although not limited thereto.

The processor 120 may adjust a gain of the detail enhancement filter based on brightness information of the display and a gain of the noise filter. The processor 120 may detect edges or image details from an image, and apply the detail enhancement filter to an area including edges or image details or an entire of the image.

Also, the processor 120 may obtain a detail-enhanced image by a weighted sum of an original image to which the detail enhancement filter has not been applied and an image to which the detail enhancement filter has been applied. At this time, the processor 120 may adjust a weight of the image to which the detail enhancement filter has been applied, based on brightness information of the display, although not limited thereto.

The contrast ratio enhancement processing may be processing for enhancing gray-scale expression of an image, and the processor 120 may perform contrast ratio enhancement processing by applying a contrast ratio enhancing curve to an image. The processor 120 may set a contrast ratio enhancing curve based on brightness information of the display. For example, the processor 120 may set a shape or slope of a contrast ratio enhancing curve based on brightness information of the display. The processor 120 may identify a contrast ratio enhancing curve to be applied to an image from among a plurality of contrast ratio enhancing curves, based on mapping information in which the plurality of contrast ratio enhancing curves are mapped to brightness information of the display.

The processor 120 may perform contrast ratio enhancement processing by applying the set contrast ratio enhancing curve to the image.

As described above, the processor 120 may obtain a second image by performing image quality processing, such as noise processing, detail enhancement processing, and contrast ratio enhancement processing, on a first image. The processor 120 may perform a control of displaying the second image on the display 140.

The display 140 according to one or more embodiments may generate a driving signal by converting an image signal, a data signal, an On-Screen Display (OSD) signal, or a control signal, for example, processed by the processor 120. The display 140 may be implemented as a Plasma Display Panel (PDP), a Liquid Crystal Display (LCD), Organic Light Emitting Diodes (OLEDs), or a flexible display, for example, or may be implemented as a 3D display. Also, the display 140 may be configured as a touch screen and used as an input device as well as an output device.

The display 140 may include a display panel and a backlight unit, and brightness information of the display according to one or more embodiments may include brightness information of the backlight unit.

The display 140 may display the second image on which image quality processing including noise processing, detail enhancement processing, or contrast ratio enhancement processing, for example, has been performed.

The wireless communicator 150 according to one or more embodiments may transmit/receive data or a signal through infrared (IR), Bluetooth, Bluetooth low energy (BLE), wireless LAN (for example, Wi-Fi), or ultrasonic waves, zigbee, for example, in correspondence to the performance and structure of the display device 100.

The wireless communicator 150 may transmit/receive a signal to/from the control device 1000 under a control by the processor 120. The wireless communicator 150 may include an IR module for transmitting/receiving a signal to/from the control device 100 according to an IR communication standard, although not limited thereto.

The wireless communicator 150 according to one or more embodiments may receive a control signal related to brightness adjustment of the display and including screen mode change, backlight adjustment, or brightness adjustment, for example, from the control device 1000.

FIG. 11 is a block diagram showing a configuration of a display device according to one or more embodiments.

Referring to FIG. 11, a display device 1100 of FIG. 11 may be an embodiment of the display device 100 described with reference to FIGS. 1 to 10.

Referring to FIG. 11, the display device 1100 according to one or more embodiments may include a tuner 1140, a processor 1110, a display 1120, a communicator 1150, a sensor 1130, an input/output device 1170, a video processor 1180, an audio processor 1185, an audio output device 1160, a memory 1190, and a power supply 1195.

The communicator 1150 of FIG. 11 may be a component including the communication interface included in the image receiver 110 of FIG. 10 and the wireless communicator 150, the input/output device 1170 of FIG. 11 may be a component corresponding to the input/output interface included in the image receiver 110 of FIG. 10, the processor 1110 of FIG. 11 may be a component corresponding to the processor 120 of FIG. 10, the memory 1190 of FIG. 11 may be a component corresponding to the memory 130 of FIG. 10, and the display 1120 of FIG. 11 may be a component corresponding to the display 140 of FIG. 10.

The tuner 1140 according to one or more embodiments may tune and select only a frequency of a channel which the display device 1100 intends to receive from among many radio wave components through amplification, mixing, and resonance of broadcast signals received by wire or wirelessly. The broadcast signals may include audio, video, and additional information (for example, EPG).

The tuner 1140 may receive a broadcast signal from various sources, such as terrestrial broadcasting, cable broadcasting, satellite broadcasting, and Internet broadcasting. The tuner 1140 may receive a broadcast signal from a source, such as analog broadcasting or digital broadcasting.

The sensor 1130 may detect a user's voice, a user's image, or a user's interaction, and include a microphone 1131, a camera 1132, and an optical receiver 1133.

The microphone 1131 may receive a user's uttered voice. The microphone 1131 may convert the received voice into an electrical signal and output the electrical signal to the processor 1110. The user's voice may include, for example, a voice corresponding to a menu or function of the display device 1400.

The camera 1132 may receive an image (for example, consecutive frames) corresponding to a user's motion including a gesture within a camera recognition range. The processor 1110 may use a recognition result of the received motion to select a menu displayed on the display device 1100 or perform a control corresponding to the motion recognition result.

The optical receiver 1133 may receive an optical signal (including a control signal) from an external control device through an optical window of a bezel of the display 1120. The optical receiver 1133 may receive an optical signal corresponding to a user input (for example, a touch, pressing, a touch gesture, a voice, or a motion) from the control device. A control signal may be extracted from the received optical signal according to a control by the processor 1110.

The processor 1110 may perform a function of controlling overall operations of the display device 1100 and signal flows between internal components of the display device 1100 and processing data. The processor 1110 may execute, according to a user's input or satisfaction of a preset, stored condition, Operating System (OS) and various applications stored in the memory 1190.

The processor 1110 may include Random Access Memory (RAM) used to store a signal or data received from outside of the display device 1100 or used as a storage area corresponding to various tasks performed in the display device 1100, Read Only Memory (ROM) in which a control program for controlling the display device 1100 is stored, and a processor.

The video processor 1180 may process video data received by the display device 1100. The video processor 1180 may perform various image processing, such as decoding, scaling, noise filtering, frame rate conversion, and resolution conversion, on the video data.

The audio processor 1185 may process audio data. The audio processor 1185 may perform various image processing, such as decoding, amplification, and noise filtering, on the audio data. Meanwhile, the audio processor 1185 may include a plurality of audio processing modules for processing audio corresponding to a plurality of pieces of content.

The audio output device 1160 may output audio included in a broadcast signal received through the tuner 1140 under a control by the processor 1110. The audio output device 1160 may output audio (for example, a voice, sound) received through the communicator 1150 and/or the input/output device 1170. Also, the audio output device 1160 may output audio stored in the memory 1190 under a control by the processor 1110. The audio output device 1160 may include at least one of a speaker, a headphone output terminal, or a Sony/Philips Digital Interface (S/PDIF) output terminal.

The power supply 1195 may supply power received from an external power source to the internal components of the display device 1100 under a control by the processor 1110. Also, the power supply 1195 may supply power output from one, two or more batteries located inside the display device 1100 to the internal components under a control by the processor 1110.

The memory 1190 may store various data, programs or applications for driving and controlling the display device 1100 under a control by the processor 1110. The memory 1190 may include a broadcast receiving module, a channel control module, a volume control module, a communication control module, a voice recognition module, a motion recognition module, an optical receiver module, a display control module, an audio control module, an external input control module, a power control module, a power control module for an external device wirelessly (for example, Bluetooth) connected thereto, voice database (DB), or motion database (DB). The modules and databases of the memory 1490, may be implemented as software to perform a broadcast reception control function, a channel control function, a volume control function, a communication control function, a voice recognition function, a motion recognition function, an optical reception control function, a display control function, an audio control function, an external input control function, a power control function, or a power control function for an external device wirelessly (for example, Bluetooth) connected thereto, in the display device 1400. The processor 1410 may perform the respective functions by using the software stored in the memory 1490.

Meanwhile, the block diagrams of the display devices 100 and 1100 shown in FIGS. 10 and 11 are block diagrams according to one or more embodiments. The components of the block diagrams may be integrated, another component(s) may be added, according to specifications of the display devices 100 and 1100 actually implemented. For example, two or more components may be integrated into one component, or one component may be separated into two or more components. Also, functions performed in the individual blocks are provided to describe the embodiments, and the detailed operations or devices for the functions do not limit the scope of rights of the present disclosure.

The operating method of the display device according to one or more embodiments may be implemented in a program command form that can be executed by various computer means, and may be recorded on computer-readable media. The computer-readable media may also include, alone or in combination with program commands, data files, data structures, and the like. Program commands recorded in the media may be the kind for the purposes of the disclosure or available to those of ordinary skill in the computer software field. Examples of the computer-readable media include magnetic media, such as hard disks, floppy disks, and magnetic tapes, optical media, such as CD-ROM and DVD, magneto-optical media such as floptical disks, and hardware devices, such as ROM, RAM, flash memory, and the like, configured to store and execute program commands. Examples of the program commands include high-level language codes that can be executed on a computer through an interpreter or the like, as well as machine language codes produced by a compiler.

The operating method of the display device according to the disclosed embodiments may be included in a computer program product and provided. The computer program product may be traded between a seller and a purchaser as a commodity.

The computer program product may include a S/W program and computer-readable storage media in which the S/W program is stored. For example, the computer program product may include a product in the form of a S/W program (e.g., a downloadable app) that is electronically distributed through a manufacturer of an electronic device or an electronic marketplace (e.g., Google Play Store or AppStore). For electronic distribution, at least a part of the S/W program may be stored on storage media or may be created temporarily. In this case, the storage media may be storage media of a server of a manufacturer, a server of an electronic marketplace, or a relay server for temporarily storing the SW program.

The computer program product may include, in a system configured with a server and a client device, storage media of the server or storage media of the client device. Based on there being a third device (e.g., a smart phone) communicatively connected to the server or the client device, the computer program product may include storage media of the third device. The computer program product may include a S/W program itself transmitted from the server to the client device or to the third device, or from the third device to the client device.

In this case, one of the server, the client device, or the third device may execute the computer program product to perform the method according to the disclosed embodiments. Two or more of the server, the client device, and the third device may execute the computer program product to distribute and perform the method according to the disclosed embodiments.

For example, a server (e.g., a cloud server or an artificial intelligence server) may execute a computer program product stored on the server to control a client device communicatively connected to the server to perform the method according to the disclosed embodiments.

So far, although the embodiments have been described in detail, the scope of rights of the disclosure is not limited to these embodiments, and various modifications and variations made by those skilled in the art based on the fundamental concept of the disclosure as defined by the appended claims may also belong to the scope of rights of the disclosure.

What is claimed is:

1. A display device comprising:
a display;
one or more processors; and
memory storing one or more instructions that, when executed by the one or more processors, cause the display device to:
obtain first brightness information of the display;
set one or more image quality processing parameters based on the first brightness information;
perform image quality processing on a first image to obtain a second image based on the one or more image quality processing parameters; and
control the display to display the second image.

2. The display device of claim 1, wherein the image quality processing comprises at least one of noise processing, detail enhancement processing, or contrast ratio enhancement processing.

3. The display device of claim 2, wherein the display device is further configured to execute the one or more instructions to:
adjust a gain of a noise filter used for the noise processing based on the first brightness information; and
obtain the second image by filtering the first image based on the noise filter.

4. The display device of claim 3, wherein the noise filter comprises a low-pass filter, and
wherein the display device is further configured to execute the one or more instructions to:
increase the gain of the noise filter based on a brightness value indicated by the first brightness information increasing; and
decrease the gain of the noise filter based on the brightness value decreasing.

5. The display device of claim 3, wherein the display device is further configured to execute the one or more instructions to:
adjust a gain of a detail enhancement filter used for the detail enhancement processing based on the first brightness information and the gain of the noise filter, and
obtain the second image by filtering the first image based on the detail enhancement filter.

6. The display device of claim 5, wherein the detail enhancement filter comprises a high-pass filter, and
wherein the display device is further configured to execute the one or more instructions to:
increase the gain of the detail enhancement filter based on the gain of the noise filter increasing; and
decrease the gain of the detail enhancement filter based on the gain of the noise filter decreasing.

7. The display device of claim 2, wherein the display device is further configured to execute the one or more instructions to:
set a contrast ratio enhancing curve used for the contrast ratio enhancement processing based on the first brightness information; and
obtain the second image based on applying the contrast ratio enhancing curve to the first image.

8. The display device of claim 7, wherein the display device is further configured to execute the one or more instructions to set the contrast ratio enhancing curve based on mapping information in which a plurality of contrast ratio enhancing curves are mapped to second brightness information of the display.

9. The display device of claim 1, further comprising a wireless communicator configured to receive a user input for adjusting brightness of the display,
wherein the display device is further configured to execute the one or more instructions to obtain the first brightness information based on the user input for adjusting the brightness of the display.

10. The display device of claim 9, wherein the user input comprises at least one of an input for changing a screen mode of the display, an input for adjusting a backlight, or an input for adjusting screen brightness.

11. An operating method of a display device, comprising:
obtaining first brightness information of a display;
setting one or more image quality processing parameters based on the first brightness information;
performing image quality processing on a first image to obtain a second image based on the one or more image quality processing parameters; and
displaying the second image.

12. The operating method of claim 11, wherein the image quality processing comprises at least one of noise processing, detail enhancement processing, or contrast ratio enhancement processing.

13. The operating method of claim 12, wherein the setting the one or more image quality processing parameters comprises adjusting a gain of a noise filter used for the noise processing based on the first brightness information, and
wherein the performing the image quality processing on the first image comprises filtering the first image based on the noise filter, to obtain the second image.

14. The operating method of claim 13, wherein the noise filter comprises a low-pass filter, and
wherein the adjusting the gain of the noise filter comprises:
increasing the gain of the noise filter based on a brightness value indicated by the first brightness information increasing; and
decreasing the gain of the noise filter based on the brightness value decreasing.

15. A non-transitory computer-readable recording medium having instructions recorded thereon, that, when executed by one or more processors, cause the one or more processors to:
obtain first brightness information of the display;
set one or more image quality processing parameters based on the first brightness information;
perform image quality processing on a first image to obtain a second image based on the one or more image quality processing parameters; and
control the display to display the second image.
